(19) United States
(12) Patent Application Publication
(10) Pub. No.: US 2022/0308085 A1
(43) Pub. Date: Sep. 29, 2022

(54) ACCELEROMETER DEVICE WITH IMPROVED BIAS STABILITY

(71) Applicant: NORTHROP GRUMMAN LITEF GMBH, Freiburg (DE)

(72) Inventors: Stefan König, Staufen (DE); Markus Ruf, Waldkirch (DE)

(21) Appl. No.: 17/616,311

(22) PCT Filed: May 15, 2020
(86) PCT No.: PCT/EP2020/063722

§ 371 Date: Dec. 3, 2021

(30) Foreign Application Priority Data
Jun. 4, 2019 (DE) 10 2019 114 996.7

(51) Int. Cl. G01P 15/125

(52) U.S. Cl. CPC G01P 15/125; G01P 2015/0814

(57) ABSTRACT

An acceleration sensor (100) has a sensor mass (120) which is movably mounted over a substrate (120) by means of spring elements (130), so as to move along a movement axis (x), first trim electrodes (140), which are connected to the sensor mass (120), and sensor electrodes (160), which are connected to the sensor mass (120). The acceleration sensor (100) has, in addition, second trim electrodes (150), which are connected to the substrate (110) and associated with the first trim electrodes (140), and detection electrodes (170), which are connected to the substrate (110) and associated with the sensor electrodes (160). The sensor electrodes (160) and the detection electrodes (170) are suitable for deflecting the sensor mass (120) along the movement axis (x) and for measuring a first electrostatic force that is exerted on the sensor mass (120) by the sensor electrodes (160) and the detection electrodes (170). A second electrostatic force is produced on the sensor mass (120) by applying an electric trim voltage between the first trim electrodes (140) and the second trim electrodes (150).

### RELATED APPLICATIONS

The present invention is a U.S. National Stage under 35 USC 371 patent application, claiming priority to Serial No. PCT/EP2020/063722, filed on May 15, 2020, which claims priority from German Patent Application No. 10 2019 114 996.7 filed 4 Jun. 2019, the entirety of both of which are incorporated herein by reference.

The present invention relates to devices and methods for measuring an acceleration with a high stability of a bias of the measuring device.

Electrical accelerometers for the measurement of acceleration are used in various applications. In this process, a mass component is often mounted over a substrate by means of spring elements, the deflection of which is measured in the case of acceleration present. In addition to the forces exerted by the spring elements, different electrostatic forces can also act on the sensor mass. In particular, in addition to the electrodes required for controlling the sensor mass and/or reading out the effective acceleration, so-called trim electrodes can also be present, which serve to influence the effective spring constant of the system by adjusting the voltage applied between the trim electrodes. Thus, an electrostatic force can be exerted on the sensor mass by the trim electrodes, which counteracts the spring force and compensates it in a first approximation (i.e., for small deflections of the sensor mass). The movement of the sensor mass then proceeds as if there were effectively no restoring spring.

WO 2015/052487 A1 discloses an accelerator in which the sensor mass can be brought into a position in which an electrostatic spring force is identical to a mechanical spring force.

WO 2016/120319 A1 discloses an accelerator in which a trim voltage can be applied to compensate for spring forces acting on the sensor mass.

JP 2000/180180 A and US 2005/0001275 A1 disclose the use of trim electrodes in accelerators.

Due to manufacturing tolerances, aging or environmental influences such as temperature fluctuations, the respective subsystems that cause the various forces acting on the sensor mass may have different force-free positions. For example, the deflection of the sensor mass for which no spring force occurs may differ from the deflection for which no electrostatic forces are exerted by the trim electrodes and/or the control/readout electrodes. This can lead to a preload of the spring elements during operation of the accelerometer, which is perceived by the control/readout electrodes and which can falsify the measurement result. This bias of the measurement must be corrected for correct results.

On one hand, it is therefore advantageous to operate an accelerometer in such a manner that an operating point of the sensor mass, i.e., the deflection of the sensor mass during operation, is as symmetrical as possible to the structure of the remaining sensor components in order to reduce the bias. In addition, it is desirable that the bias remains constant over longer periods of time in order to avoid ongoing adjustment of the corrections required by the bias.

It is therefore the object of the present invention to provide an accelerometer and a method of operating the same, which enable the accelerometer to be operated at an operating point at which the bias is as small as possible and as stable as possible.

This object is achieved by the subject matter of the independent claims.

An accelerometer can include a sensor mass which is mounted over a substrate by means of spring elements so as to move along a movement axis, first trim electrodes that are connected to the sensor mass, and sensor electrodes that are connected to the sensor mass. The accelerometer can, in addition, include second trim electrodes, which are connected to the substrate and assigned to the first trim electrodes, and detection electrodes, which are connected to the substrate and assigned to the sensor electrodes. In this process, the sensor electrodes and the detection electrodes are suitable for deflecting the sensor mass along the movement axis and for measuring the deflection and a first electrostatic force that is exerted on the sensor mass by the sensor electrodes and the detection electrodes. When the sensor mass is deflected along the movement axis, a spring force acting on the sensor mass is generated by the spring elements. A second electrostatic force acting on the sensor mass is generated by applying an electrical trim voltage between the first trim electrodes and the second trim electrodes. A relationship between the first electrostatic force and the deflection of the sensor mass is determined by the sensor electrodes and the detection electrodes for at least two different trim voltages, and a neutral point for the deflection is determined therefrom where the respective first electrostatic forces are equal for the different trim voltages. The deflection of the sensor mass is then set by the sensor electrodes and the detection electrodes with respect to the neutral point.

The sensor mass experiences three types of forces in such an accelerometer. A restoring spring force acts on the sensor mass via the spring elements. The sensor and detection electrodes provided for controlling the sensor mass and/or reading out the effective acceleration generate a first electrostatic force, while the trim electrodes generate a second electrostatic force. In this process, the effects of the spring force and the second electrostatic force can be considered combined as the effective spring force, to which the first electrostatic force read out by the sensor must be equal for a rest position of the sensor mass.

Varying the trim voltage that leads to the second electrostatic force changes the magnitude of this effective spring force. Variation of the trim voltage therefore leads to a variation of the perceived effective spring constant of the combined system of spring elements and trim electrodes in first order, i.e., for small deflections.

For a given trim voltage, i.e., for a given effective spring constant, the dependence of the first electrostatic force, i.e., the force acting on the sensor mass detected by the detection electrodes of the accelerometer, on the deflection of the sensor mass is determined. Hence, which force leads to which deflection is being measured. For small deflections around the mechanical rest point of the spring element-sensor mass system, this relationship takes the form of a straight line the slope of which corresponds to the effective spring constant.

If the trim voltage is now changed and the relationship between the effectively measured force and the deflection is measured again, another straight line with a different slope is obtained. At the intersection of the two straight lines, the same second electrostatic force is present for the different trim voltages at the same deflection. In fact, all the straight lines determined for different trim voltages intersect at a single point, which will be referred to below as the “neutral point”, in a first approximation, i.e., for deflections in which the second electrostatic force generated by the trim electrodes varies linearly with the deflection.

This neutral point is stable to fluctuations in the applied trim voltage, since such fluctuations do not affect the force acting on the sensor mass. A bias present at the neutral point is therefore stabilized against changes affecting the trim electrodes.

In addition, the bias at the neutral point is particularly small since the sensor mass is symmetrical to the sensor structure. This can be understood as follows. If the spring force is denoted by Ff, the first electrostatic force by Fd, and the second electrostatic force generated by the trim electrodes by Ft, then the following applies to the force equilibrium:

According to the definition of the neutral point, the first electrostatic force must, at the neutral point n, be the same for different trim voltages U1 and U2. In addition, the sensor mass has a given deflection “n” at the neutral point. Therefore, the force exerted by the spring elements is also the same at the neutral point for different trim voltages. It follows that the second electrostatic force must also be the same for different trim voltages:

Fd(U1,n)=Fd(U2,n);Ff(U1,n)=Ff(U2,n);→Ft(U1,n)=Ft(U2,n)

Thus, the sensor mass must, at the neutral point, be symmetrical with respect to the trim electrodes, since otherwise the condition Ft(U1,n)=Ft(U2,n) cannot be fulfilled. If the trim electrodes are arranged as pairings of plate capacitors, for example, it even follows that the second electrostatic force at the neutral point is equal to zero, since all forces cancel each other out due to the symmetrical arrangement.

It is therefore possible to operate the accelerometer with a small and relatively stable bias as soon as the sensor mass has been placed at an initial position adjacent to the neutral point or even at the neutral point.

After setting the deflection with respect to the neutral point in such a manner, the trim voltage can be adjusted such that the second electrostatic force partially or fully compensates for the spring force. The relationship between the first electrostatic force and the deflection is approximated to a horizontal line in this case, i.e., essentially the same effective force occurs for all deflections. Thus, a small change in position from the neutral point only results, like a change in trim voltage, in a negligible change in the force measured by the sensor and detection electrodes and hence in the bias. Thus, the stability of the bias is further increased.

The sensor electrodes and the detection electrodes can be divided into first pairings of sensor electrodes and detection electrodes and second pairings of sensor electrodes and detection electrodes. In this process, the first pairings and the second pairings can be arranged at different positions along the movement axis, and a predetermined voltage can be alternately applied to the sensor electrodes and detection electrodes of the first pairings and the sensor electrodes and detection electrodes of the second pairings with a duty cycle. The first electrostatic force can then be changed by changing the duty cycle.

By spatially separating the sensor and detection electrodes along the movement axis, the first electrostatic force can be varied by alternating the application of a single constant voltage to the spatially separated electrode pairings. For example, if the duty cycle is 50/50 for identically configured first and second electrode pairings, then there is no first electrostatic force. If the duty cycle is changed in one direction, e.g., to 70/30, a first electrostatic force will develop in the one direction of the movement axis, while, if changed in the other direction, e.g., to 30/70, the electrostatic force will act in the opposite direction. The strength of the force can thus be adjusted by the number of times the one set of pairings are acted upon versus the other pairings in a given time unit. In principle, this also allows an asymmetrical structure of the pairings, since a duty cycle can always be found for which an averaged freedom from forces is achieved. Thus, it is possible to vary the effective or second electrostatic force in a simple manner using a single predetermined voltage, whereby the process of finding the neutral point is simplified.

While the predetermined voltage is applied to the respective sensor electrodes and detection electrodes, a capacitance of the capacitors formed by the sensor electrodes and detection electrodes can be determined, and the deflection of the sensor mass can be determined via a difference in capacitance between the first pairings of sensor electrodes and detection electrodes and the second pairings of sensor electrodes and detection electrodes.

The relationship between the first electrostatic force and the deflection can be determined via the relationship between the present duty cycle and the difference in capacitance.

When the predetermined voltage is applied to the respective pairings of sensor and detection electrodes, the inflow of charge to the capacitor formed by these electrodes can be measured, e.g., via an appropriate amplifier. Since the applied voltage is known, the total capacitance of the electrodes to which voltage is applied can be determined from this. Since the capacitance depends on the distance between the electrodes, the difference in the total capacitances of the two pairing groups is a measure of the deflection of the sensor mass. An appropriate calibration therefore allows a deflection to be derived from the measurement of the capacitances.

However, similarly, it is also possible to determine the relationship between the first electrostatic force and the deflection of the sensor mass directly as a relationship between the duty cycle of the change in voltage application and the difference in capacitance. The neutral point is then understood to be a specific difference in capacitance where the duty cycle is the same for different trim voltages.

For this purpose, the duty cycle can, in each case, be changed for a trim voltage, and the difference in capacitance is determined for each duty cycle. The duty cycle that is required to set the deflection in the direction of the neutral point is set in such a manner that the same difference in capacitance is aimed at or occurs for each of the different trim voltages. In this way, the deflection with respect to the neutral point can be set in a simple manner without the need for calibration or conversion of the measured values.

Voltages applied to the first trim electrodes, the second trim electrodes, the sensor electrodes and/or the detection electrodes can be automatically adjusted by a control loop in such a manner that the deflection is controlled with respect to the neutral point. For this purpose, the duty cycle can, for example, be controlled in such a manner that the difference in capacitance is achieved at the neutral point. The required difference in capacitance at the neutral point can be determined continuously by modulating the voltages applied to the trim electrodes. This enables automatic tracking of the sensor mass in the direction of the neutral point, even if this should shift over time or due to environmental influences.

Voltages applied to the first trim electrodes and the second trim electrodes can be automatically adjusted by another control loop in such a manner that the second electrostatic force partially or fully compensates for the spring force. This ensures that the sensor mass at or near the neutral point is not subject to any (or approximately any) effective spring force, even if sensor parameters change over time or due to environmental influences.

Setting the sensor mass with respect to the neutral point can be an approximation of the deflection of the sensor mass to the neutral point or setting the deflection of the sensor mass to the neutral point. As already discussed above, this increases the bias stability.

A method for setting the deflection of the sensor mass of an accelerometer as described above may include: determining a relationship between the first electrostatic force and the deflection of the sensor mass for at least two different trim voltages; determining a neutral point for the deflection where, for the different trim voltages, the respective first electrostatic forces are equal, from the relationships between the first electrostatic force and the deflection of the sensor mass; and setting the deflection of the sensor mass with respect to the neutral point.

The invention will be described in an exemplary manner in the following text, with reference to the figures. The invention, however, is not to be restricted to the following examples, it is rather solely determined by the subject matter of the claims.

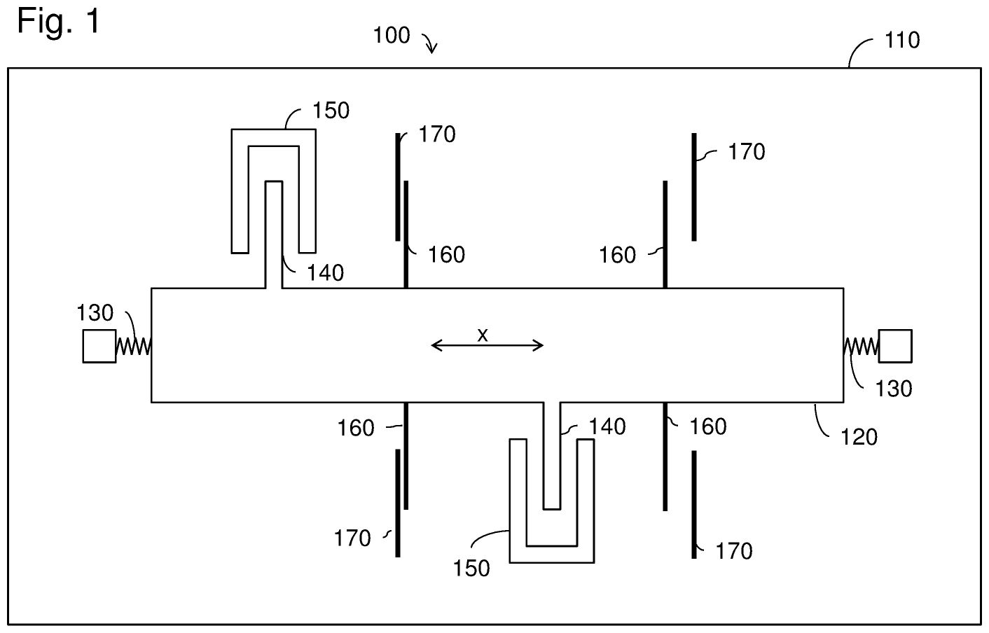

FIG. 1 shows a schematic representation of an accelerometer;

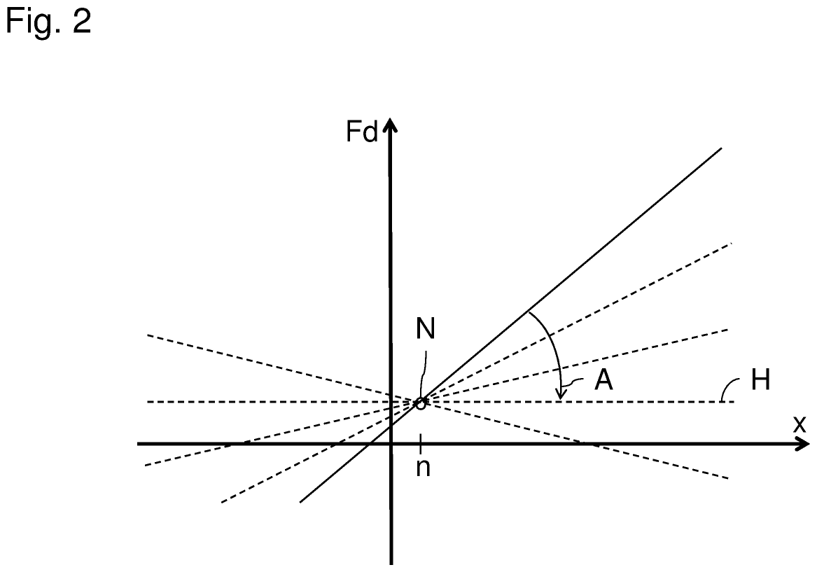

FIG. 2 shows a schematic representation of the dependence of a force measured by an accelerometer on the deflection of its sensor mass at different trim voltages;

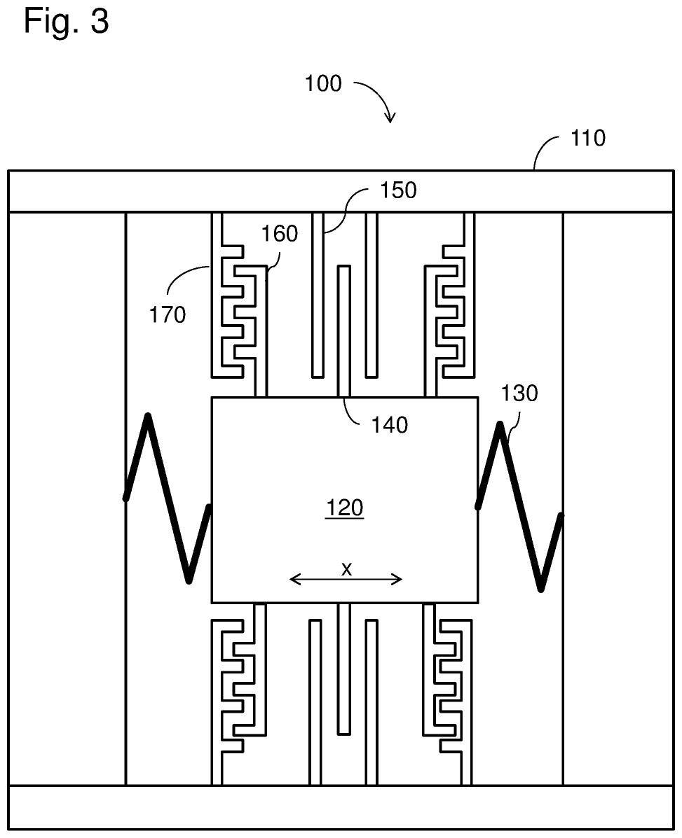

FIG. 3 shows a schematic representation of another accelerometer; and

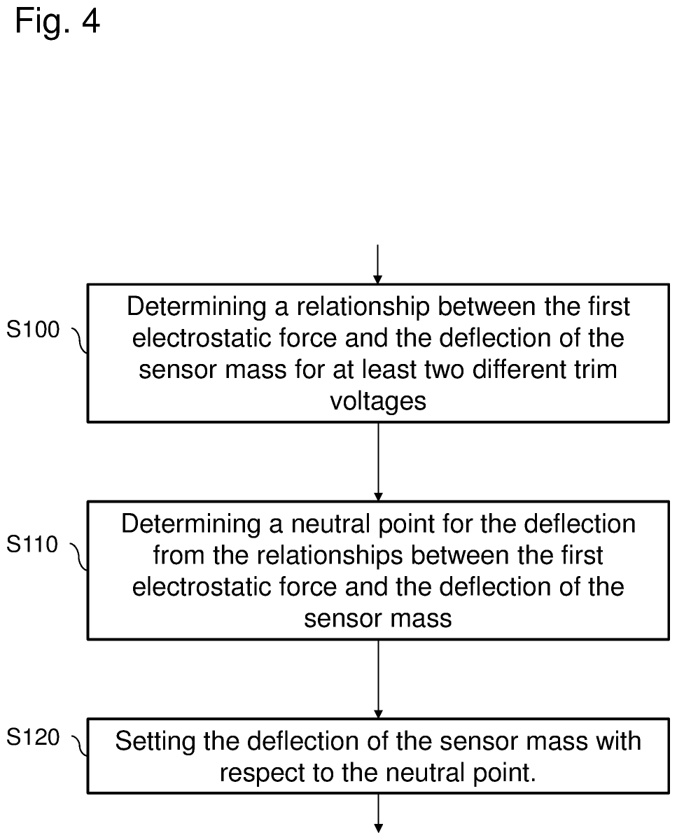

FIG. 4 shows a schematic flow chart of a method for setting a deflection of the sensor mass of an accelerometer to a position with a stabilized bias.

FIG. 1 shows a schematic representation of an accelerometer 100.

The accelerometer 100 includes a substrate 110. A sensor mass 120 is mounted over the substrate 110 via spring elements 130 so as to be movable along a movement axis x. The spring elements 130 are firmly connected to the substrate 110 on a first side of the spring elements 130 and firmly connected to the sensor mass 120 on a second side of the spring elements 130. The spring elements 130 allow the sensor mass 120 to be deflected along the movement axis x. For example, the spring elements 130 can be designed as flexible bar springs extending perpendicular to the movement axis x and thus allowing a movement solely along the movement axis x, whereas a movement perpendicular to the movement axis x is not possible. However, the spring elements 130 can also have any other form which causes the sensor mass 120 to be deflected along the movement axis x.

First trim electrodes 140 are connected to the sensor mass 120. In this process, the first trim electrodes 140 are firmly connected to the sensor mass 120, e.g., the sensor mass 120 and the first trim electrodes 140 can be formed integrally, i.e., the first trim electrodes 140 are an integral component of the sensor mass 120.

Second trim electrodes 150 are connected to the substrate 110 and assigned to the first trim electrodes 140. In this process, the second trim electrodes 150 are firmly connected to the substrate 110. For example, the second trim electrodes 150 can be integral components of the substrate 110.

The pairings of first trim electrodes 140 and second trim electrodes 150 are formed such that, in a given position of the sensor mass 120, no force generated by the first trim electrodes 140 and the second trim electrodes 150 acts on the sensor mass 120. However, when deflected from this position, an electrostatic force Ft is generated which acts on the sensor mass 120 via the trim electrodes 140, 150.

The first trim electrodes 140 and the second trim electrodes 150 need not be mounted symmetrically on the sensor mass 120 or the substrate 110. For example, all first trim electrodes 140 can be located on one side of the sensor mass 120 or at one end of the sensor mass 120.

In deflecting the sensor mass 120 along the movement axis x, the spring elements 130 generate a spring force Ff which moves the sensor mass 120 back into an initial position, in which the forces generated by the individual spring elements 130 compensate, or in which these forces disappear (mechanical zero point). At the same time, by applying an electrical trim voltage between the first trim electrodes 140 and the second trim electrodes 150, the electrostatic force Ft acting on the sensor mass 120 can be generated which is added to the spring force Ff to become an effective spring force.

Therefore, it is possible to freely set the spring hardness or stiffness of the accelerometer 100 via a trim voltage applied between the first trim electrodes 140 and the second trim electrodes 150. Thus, for example, it can be achieved that the spring force Ff and the electrostatic force Ft are fully compensated, so that, when the sensor mass 120 is deflected, there is no longer a restoring force. However, the electrostatic force Ft can also overcompensate, i.e., exceed, the spring force Ff, so that, even in the case of only a minor deflection of the sensor mass 120, the electrostatic force Ft increases the sensor mass 120 to a large deflection. Since this can lead to immediate overcontrol of the sensor mass 120, the accelerometer 100 should in this manner only be operated with additional resetting electronics in a closed loop.

The accelerometer 100 additionally includes sensor electrodes 160 for reading out the acceleration which is connected to the sensor mass 120 and to which schematically represented detection electrodes 170 are assigned which are connected to the substrate 110. A voltage between the sensor electrodes 160 and the detection electrodes 170 generates an electrostatic force Fd acting on the sensor mass 120, which can be used to deflect the sensor mass 120. For a fixed voltage between sensor electrodes 160 and detection electrodes 170, the charge, or a capacitance that can be derived therefrom, depends on the deflection of the sensor mass 120 along the movement axis x. This allows to determine the deflection of the sensor mass 120 via the sensor electrodes 160 and the detection electrodes 170.

If the sensor mass 120 is to be at rest, the various forces acting on it must be balanced, i.e., Fd+Ft+Ff=0. If the first electrostatic force Fd is understood to be the force measured by the accelerometer 100 and the combination of the spring force Ff and the second electrostatic force Ft is understood to be the effective spring force, then a linear relationship between the first electrostatic force and the deflection, the slope of which depends on the trim voltage applied, emerges for small deflections.

This is shown schematically in FIG. 2, which gives graphs for the dependence of the first electrostatic or effectively measured force Fd on the deflection along the movement axis x for different trim voltages. Each of the straight lines represents a force-path characteristic line of the system for a given trim voltage. These characteristic lines can be determined for a given trim voltage in each case by adjusting various forces exerted by the detection electrodes 170 on the sensor electrodes 160 and subsequent reading of the resulting deflections.

If this measurement is carried out at least twice for different trim voltages, the point N in the diagram where the first electrostatic force Fd leads to the same deflection “n” for all trim voltages is obtained as the intersection of all straight lines. This deflection is referred to as a “neutral point”.

By correspondingly varying the trim voltage and the voltages between the sensor electrodes 160 and the detection electrodes 170, the neutral point for deflection can be determined in the accelerometer 100 and targeted as a starting point for acceleration measurements. Changes in the trim voltage do not affect the forces acting on the sensor mass 120 at this point. Thus, a bias acting on the acceleration measurement is stable to such changes, whereby the reliability of the sensor is increased over long run times. Thus, if the sensor mass 120 is brought to an initial position that approximates or corresponds to the neutral point, the bias stability can be increased.

In addition, after the initial position of the sensor mass has approximated the neutral point or has taken it up, the trim voltage can be changed in such a manner that the second electrostatic force Ft partially or even completely compensates for the spring force Ff. This is marked by arrow A in FIG. 2. Thus, the trim voltage is changed until the slope-free, i.e., horizontal, graph H is (nearly) reached in the force-path diagram. For such a configuration, the bias is also stable to small displacements from the neutral point, since no change in the forces acting on the sensor mass 120 occurs. This also increases long-term stability and may furthermore be advantageous for operation of the accelerometer 100 under vibration.

Both the setting of the deflection with respect to the neutral point and the adjustment of a trim voltage that fully or partially compensates for the spring force Ff can be achieved by automatically controlling the voltages applied to the trim electrodes 140, 150, the sensor electrodes 160 and the detection electrodes 170. Hereby, it is possible to keep the accelerometer 100 at the neutral point and to further stabilize the bias. In addition, the control can provide data regarding a change in the position of the neutral point over time, which can provide information about the functionality of the accelerometer 100.

It is understood that, depending on the concrete embodiment of the trim electrodes 140, 150, the sensor electrodes 160 and the detection electrodes 170, the first electrostatic force Fd, the second electrostatic force Ft and the deflection of the sensor mass 120 can be generated in different ways and read out. A concrete possibility for this is to be discussed by way of example using the accelerometer 100 shown schematically in FIG. 3.

In the accelerometer 100 of FIG. 3, the first trim electrodes 140 are formed as electrode plates, each of which is enclosed by two second trim electrodes 150 and together with these form plate capacitors. In this process, the second electrostatic force is the resultant of the forces acting on the center first trim electrode 140 from the two outer second trim electrodes 150. Thus, for a central positioning of the first trim electrodes 140, the latter is free of forces.

The sensor electrodes 160 and the detection electrodes 170 are formed as comb electrodes with inter-engaging electrode fingers. The sensor electrodes 160 and the detection electrodes 170 are separated along the movement axis x into two groups of pairings. In FIG. 3, the electrodes arranged at the left end of the sensor mass represent the first pairing, while the electrodes arranged at the right end represent the second pairing.

If a predetermined voltage is now applied to only one of the two pairing groups, the result is a force attributable to only the electrodes of these pairings. If one alternately changes the group of pairings to which voltage is applied, the resulting first electrostatic force depends on how long which pairing group has the voltage applied to it. In this case, a rapid change is recommended in order to suppress inertia effects or hysteresis effects as far as possible. The duty cycle for changing the voltage from one pairing group to the other thus determines whether and in which direction the first electrostatic force is formed over the averaged time.

In the example of FIG. 3, the pairings of sensor electrodes 160 and detection electrodes 170 are identical in construction. Thus, applying a predetermined voltage only to the left pairings results in an opposite force than when applying the predetermined voltage only to the right pairings. If the voltage is applied equally often to the left and right during a reference period, i.e., if a duty cycle of 50/50 is set, then no force results over the averaged time. By varying the duty cycle, it is then possible to adjust the first electrostatic force acting on the sensor mass 120 over the averaged time. In this process, the actual force naturally depends on the concrete structure of the sensor and can be calculated. The externally presettable duty cycle thus allows to preset the first electrostatic force from the outside.

At the same time, the capacitance of the capacitors formed by the electrodes can, when the predetermined voltage is applied to the electrodes, be determined from the charge flow in a manner known per se, e.g., by measuring the charge flow via mass and an amplifier capacitor. For the left group of pairings of FIG. 3, this results in the same value as for the right group of pairings. Since the capacitances depend on the distance between the respective electrodes, they are a measure of the deflection of the sensor mass 120. The difference in capacitance between the left and the right pairings can therefore be read out. From this, the deflection of the sensor mass 120 can then be determined.

In this way, it is therefore possible to determine the measured values which are necessary to derive a force-path graph for each applied trim voltage and, from this, the neutral point.

Alternatively, it is also possible to dispense with deriving the first electrostatic force from the duty cycle and the deflection from the difference in capacitance and to use these parameters directly for setting the neutral point.

To do this, different duty cycles are applied for each trim voltage, and the corresponding difference in capacitance is measured for each duty cycle. The resulting duty cycle-capacitance difference graphs intersect at a point where a duty cycle for each trim voltage results in the same difference in capacitance. Adjustment with respect to this difference in capacitance is then equivalent to setting the deflection with respect to the neutral point. In this way, the neutral point can be determined by means of directly adjustable or readable parameters, and the deflection of the sensor mass (120) can be approximated to or preferably set to the neutral point. In particular, it is possible to control for the difference in capacitance.

In this way, the neutral point can be reached and maintained in a simple manner.

FIG. 4 shows a schematic flow chart for a method of setting the neutral point, which can be carried out with an accelerometer of equivalent design to the sensors described above.

At S100, a relationship between the first electrostatic force Fd and the deflection of the sensor mass (120) for at least two different trim voltages is determined. In particular, linear force-path graphs can be determined for two or more trim voltages.

At S110, a neutral point for the deflection is determined from the relationships between the first electrostatic force Fd and the deflection of the sensor mass (120), in which the respective first electrostatic forces Fd are equal for the different trim voltages. In particular, this neutral point can be determined from the intersection of the determined force-path graphs.

At S120, the deflection of the sensor mass is set with respect to the neutral point. In particular, the deflection is set to the vicinity of the neutral point or preferably to the neutral point. This enables operation of the accelerometer at an operating point with increased long-term stability of the bias.

1. An accelerometer (100), comprising:
a sensor mass (120) which is mounted over a substrate (110) by means of spring elements (130) so as to be movable along a movement axis (x);
first trim electrodes (140) which are connected to the sensor mass (120);
sensor electrodes (160) which are connected to the sensor mass (120);
second trim electrodes (150) which are connected to the substrate (110) and are assigned to the first trim electrodes (140);
detection electrodes (170) which are connected to the substrate (110) and are assigned to the sensor electrodes (160), wherein
the sensor electrodes (160) and the detection electrodes (170) are configured to deflect the sensor mass (120) along the movement axis (x) by an applied voltage and to measure the deflection and a first electrostatic force (Fd) that is exerted on the sensor mass (120) by the sensor electrodes (160) and the detection electrodes (170) in order to determine a relationship between the first electrostatic force (Fd) and the deflection of the sensor mass (120);
in deflecting the sensor mass (120) along the movement axis (x), the spring elements (130) are configured to generate a spring force (Ff) acting on the sensor mass (120);
the accelerator (100) is configured, by applying an electrical trim voltage between the first trim electrodes (140) and the second trim electrodes (150), to generate a second electrostatic force (Ft) acting on the sensor mass (120) which is added to the spring force (Ff) to become an effective spring force;
the sensor electrodes (160) and the detection electrodes (170) are configured to determine the particular relationship between the first electrostatic force and the deflection of the sensor mass (120) for at least two different trim voltages and to determine therefrom a neutral point for the deflection is determined therefrom where the respective first electrostatic forces are equal for the different trim voltages; and
the accelerator (100) is configured to adjust the voltages applied to the first trim electrodes (140), the second trim electrodes (150), the sensor electrodes (160) and/or the detection electrodes (170) in such a manner that the deflection of the sensor mass is set by the sensor electrodes (160) and the detection electrodes (170) with respect to the neutral point.

2. The accelerometer (100) according to claim 1, wherein
after the deflection has been set with respect to the neutral point, the trim voltage is adjusted in such a manner that the second electrostatic force partially or fully compensates for the spring force.

3. The accelerometer (100) according to claim 1, wherein
the sensor electrodes (160) and the detection electrodes (170) are divided into first pairings of sensor electrodes (160) and detection electrodes (170) and second pairings of sensor electrodes (160) and detection electrodes (170);
the first pairings and the second pairings are arranged at different positions along the movement axis (x);
a predetermined voltage with a duty cycle is alternatingly applied to the sensor electrodes (160) and detection electrodes (170) of the first pairings and the sensor electrodes (160) and detection electrodes (170) of the second pairings; and
the first electrostatic force can be changed by changing the duty cycle.

4. The accelerometer (100) according to claim 3, wherein
a capacitance of the capacitors formed by the sensor electrodes (160) and detection electrodes (170) is determined, while the predetermined voltage is applied to the respective sensor electrodes (160) and detection electrodes (170);
the deflection of the sensor mass (120) is determined via a difference in capacitance between the first pairings of sensor electrodes (160) and detection electrodes (170) and the second pairings of sensor electrodes (160) and detection electrodes (170); and
the relationship between the first electrostatic force and the deflection is determined via the relationship between the present duty cycle and the difference in capacitance.

5. The accelerometer (100) according to claim 4, wherein
the duty cycle is, in each case, changed for a trim voltage, and the difference in capacitance is determined for each duty cycle; and,
in order to set the deflection with respect to the neutral point, the duty cycle is set in such a manner that the same difference in capacitance occurs for each of the different trim voltages.

6. The accelerometer (100) according to claim 1, wherein
voltages applied to the first trim electrodes (140), the second trim electrodes (150), the sensor electrodes (160) and/or the detection electrodes (170) are automatically adjusted by a control loop in such a manner that the deflection is controlled with respect to the neutral point.

7. The accelerometer (100) according to claim 1, wherein
voltages applied to the first trim electrodes (140) and the second trim electrodes (150) are automatically adjusted by a control loop in such a manner that the second electrostatic force partially or fully compensates for the spring force.

8. The accelerometer (100) according to claim 1, wherein
setting the sensor mass (120) with respect to the neutral point is an approximation of the deflection of the sensor mass (120) to the neutral point or setting the deflection of the sensor mass (120) to the neutral point.

9. A method for setting the deflection of the sensor mass (120) of an accelerometer (100) according to any one of the preceding claims, comprising:
applying voltages to the first trim electrodes (140), the second trim electrodes (150), the sensor electrodes (160) and/or the detection electrodes (170) of the accelerometer (100);
determining the particular relationship between the first electrostatic force (fd) and the deflection of the sensor mass (120) for at least two different trim voltages;
determining a neutral point for the deflection (n) where the respective first electrostatic forces are equal for the different trim voltages from the relationships between the first electrostatic force (Fd) and the deflection (n) of the sensor mass (120); and
adjusting the voltages applied to the first trim electrodes (140), the second trim electrodes (150), the sensor electrodes (160) and/or the detection electrodes (170) in such a manner that the deflection of the sensor mass (120) is set with respect to the neutral point.
